(19) United States
(12) Patent Application Publication
(10) Pub. No.: US 2013/0217322 A1
(43) Pub. Date: Aug. 22, 2013

(54) NEAR FIELD COMMUNICATION SYSTEM

(71) Applicants: Jui-Ming Wei, Zhubei City (TW); Shu-Hung Chou, New Taipei City (TW)

(72) Inventors: Jui-Ming Wei, Zhubei City (TW); Shu-Hung Chou, New Taipei City (TW)

(73) Assignee: Mediatek Inc., Hsin-Chu (TW)

(21) Appl. No.: 13/400,501

(22) Filed: Feb. 20, 2012

(51) Int. Cl. H04B 5/00

(52) U.S. Cl. 455/41.1

(57) ABSTRACT

An NFC (Near Field Communication) system is provided in the invention. The NFC system includes a power source, a capacitor, an NFC controller including an independent power domain, and a memory device disposed in the independent power domain. The capacitor is charged by the power source. The independent power domain of the NFC controller is supplied by the power source and/or the capacitor. The memory device is configured to maintain data. When the power source is removed therefrom or turned off, the independent power domain is supplied by the capacitor.

### BACKGROUND OF THE INVENTION

1. Field of the Invention

The disclosure generally relates to an NFC (Near Field Communication) system, and more particularly, relates to an NFC system including a memory device that can work normally even if a power source is removed therefrom or turned off.

2. Description of the Related Art

In an NFC system, an NFC controller can be used as a card (e.g., a card emulation mode defined in the NFC Forum) for many applications, such as Metro passing, banking, etc. The NFC controller requires an NVM (Non-Volatile Memory) so as to keep important data when a power source of the NFC system is removed therefrom or turned off

An NVM is usually an EEPROM (Electrically Erasable Programmable Read Only Memory) or a flash memory. The data stored in the NVM can be kept even when battery power is turned off. The drawbacks of the NVM are directed to its large size and high cost. The size of an EEPROM is much larger than a volatile memory, and the data density of the EEPROM is very low. On the other hand, a flash memory requires extra masks and special process, which costs a lot. Nowadays, there is still no mature NVM solution for advanced process, e.g. 40 nm or 65 nm, such that development of an NFC system with advanced processes continues to be problematic.

### BRIEF SUMMARY OF THE INVENTION

In one exemplary embodiment, the disclosure is directed to an NFC (Near Field Communication) system, comprising: a power source; a capacitor, charged by the power source; an NFC controller, comprising an independent power domain which is supplied by the power source and/or the capacitor; and a memory device, disposed in the independent power domain, and maintaining data, wherein the independent power domain is supplied by the capacitor when the power source is removed therefrom or turned off

In another exemplary embodiment, the disclosure is directed to an NFC (Near Field Communication) system, comprising: a power source; a capacitor, charged by the power source; an NFC controller, comprising an independent power domain which is supplied by the power source and/or the capacitor; an LDO (Low Dropout Regulator), disposed in the independent power domain, and converting a power voltage into a low voltage, wherein the power voltage is provided by the power source and/or the capacitor; and a memory device, disposed in the independent power domain, coupled to the low voltage of the LDO, and maintaining data, wherein the independent power domain is supplied by the capacitor when the power source is removed therefrom or turned off.

### BRIEF DESCRIPTION OF DRAWINGS

The invention can be more fully understood by reading the subsequent detailed description and examples with references made to the accompanying drawings, wherein:

FIG. 1 is a diagram for illustrating an NFC (Near Field Communication) system according to an embodiment of the invention;

FIG. 2 is a diagram for illustrating an NFC system coupled to an AP (Application Processor) host chip according to an embodiment of the invention;

FIG. 3 is a diagram for illustrating an NFC system according to an embodiment of the invention;

FIG. 4 is a diagram for illustrating an NFC system according to another embodiment of the invention; and

FIG. 5 is a diagram for illustrating an NFC controller according to an embodiment of the invention.

### DETAILED DESCRIPTION OF THE INVENTION

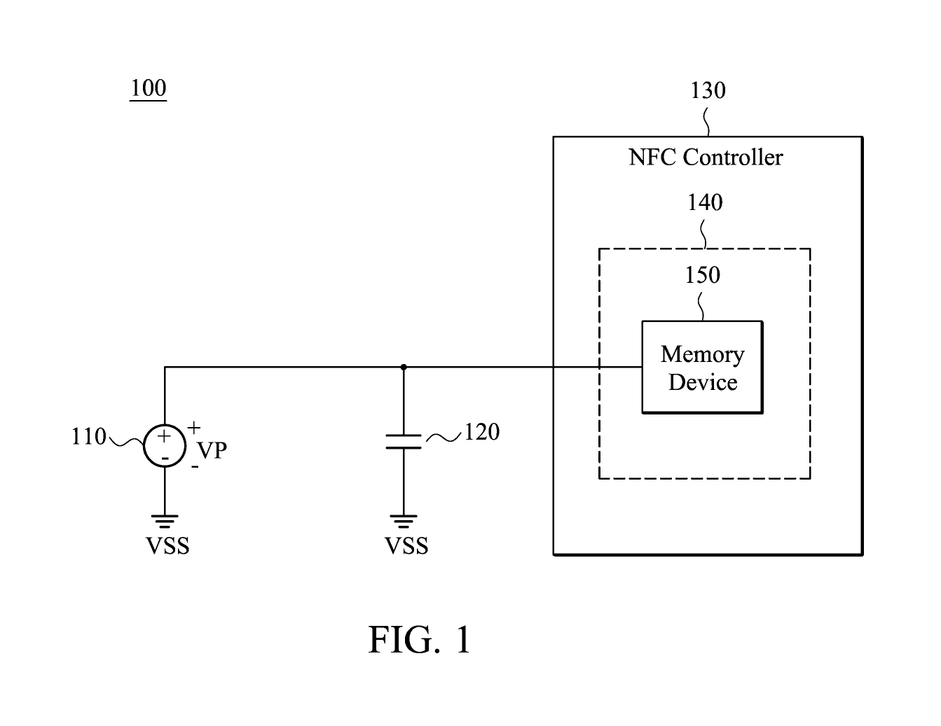

FIG. 1 is a diagram for illustrating an NFC (Near Field Communication) system 100 according to an embodiment of the invention. As shown in FIG. 1, the NFC system 100 comprises a power source 110, a capacitor 120, and an NFC controller 130. The NFC system 100 may be used in a mobile device, such as a mobile phone or a tablet PC (Personal Computer). The power source 110 may be a system battery of the NFC system 100 and provide a power voltage VP (e.g., 1.2V). In another embodiment, there may be a plurality of power sources disposed in the NFC system 100. The capacitor 120 has a large capacitance so as to store much energy. The capacitor 120 is charged by the power source 110, and has a voltage difference that is equal to the power voltage VP. The power source 110 and the capacitor 120 may be both electrically coupled to a ground voltage VSS (e.g., 0V). The NFC controller 130 comprises an independent power domain 140, which is supplied by the power source 110 and/or the capacitor 120. The independent power domain 140 may be an RTC (Real Time Clock) domain for counting time continuously.

The NFC controller 130 further comprises a memory device 150 disposed in the independent power domain 140. The power source 110 and/or the capacitor 120 provide electrical power for the independent power domain 140 and all components disposed in the independent power domain 140, such as the memory device 150, which is supplied by the independent power domain 140. The memory device 150 is configured to maintain data. In a preferred embodiment, the memory device 150 is a volatile memory, such as an SRAM (Static Random Access Memory) or one or more D-flip flops. In some embodiments, the data comprises an application configuration data and/or a patch code for use in a processor (not shown in FIG. 1) of the NFC controller 130.

It is note that when the power source 110 is removed therefrom or turned off, the independent power domain 140 is supplied by only the capacitor 120. The voltage difference of the capacitor 120 can be kept for several hours, depending on the size of the capacitor 120. Therefore, the memory device 150 disposed in the independent power domain 140 can maintain the data even if the power source 110 is removed therefrom or turned off. The memory device 150 of the NFC system 100 can be used as an NVM (Non-Volatile Memory). The size of a volatile memory (e.g., an SRAM) is much smaller than that of an NVM (e.g. an EEPROM or a flash memory), and furthermore, the volatile memory just requires a standard process. Neither special processes nor extra masks are required in the invention.

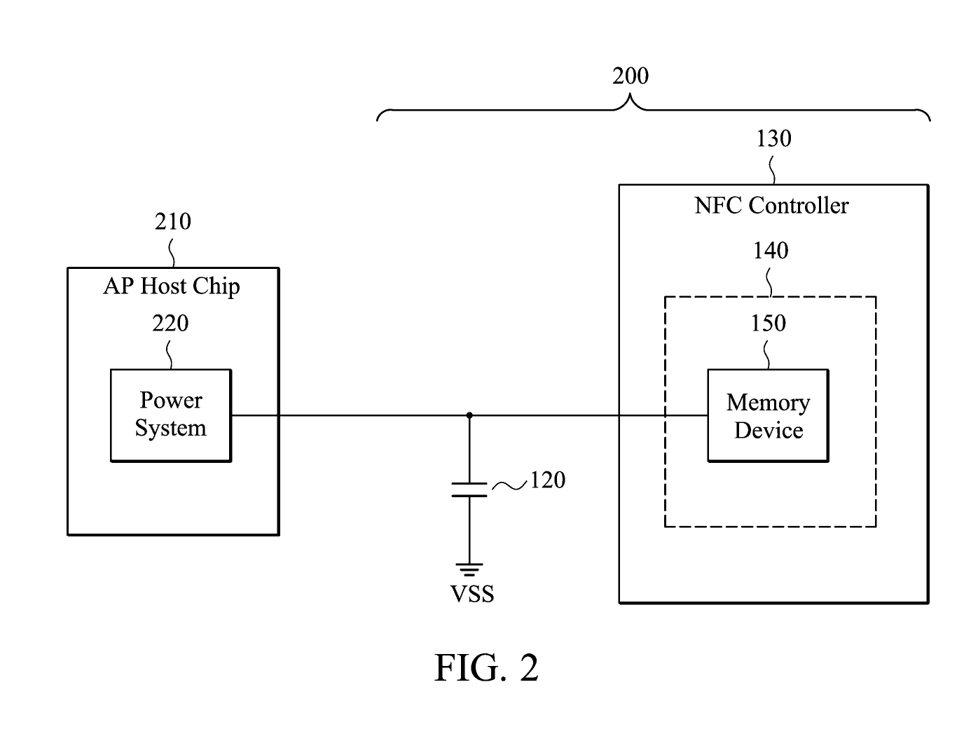

FIG. 2 is a diagram for illustrating an NFC system 200 coupled to an AP (Application Processor) host chip 210 according to an embodiment of the invention. The NFC system 200 is similar to the NFC system 100 as shown in FIG. 1. However, the power source 110 is supplied by a power system 220 of the AP host chip 210, or even replaced with the power system 220 of the AP host chip 210. In the embodiment, the NFC system 200 is electrically coupled to the power system 220 of the AP host chip 210. The power system 220 provides the power voltage VP so as to charge the capacitor 120 and supply the independent power domain 140 with electrical power. It is noted that the AP host chip 210 may be another chip which is independent of the NFC system 200.

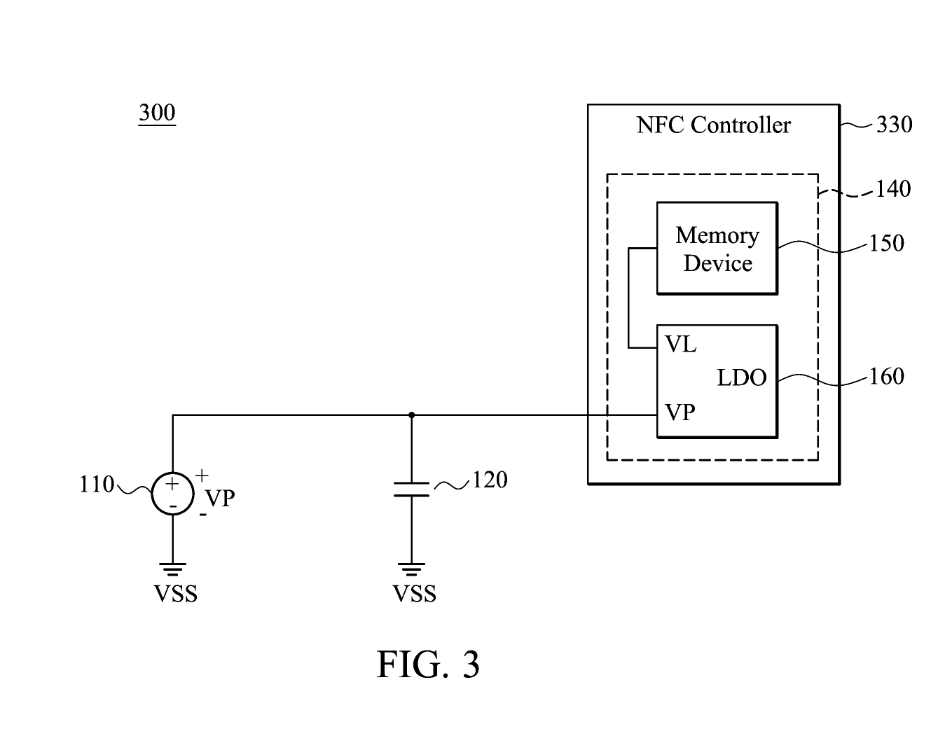

FIG. 3 is a diagram for illustrating an NFC system 300 according to an embodiment of the invention. As shown in FIG. 3, in the embodiment, the NFC controller 330 further comprises an LDO (Low Dropout Regulator) 160, which is disposed in and supplied by the independent power domain 140. The LDO 160 is electrically coupled to the power source 110 and electrically coupled to the capacitor 120. The LDO 160 is configured to convert the power voltage VP into a low voltage VL, wherein the power voltage VP may be provided by the power source 110 and/or the capacitor 120. In some embodiments, the power voltage VP may be equal to 2.8V, and the low voltage VL may be equal to 1.2V. Since the memory device 150 is electrically coupled to the LDO 160 for converting the power voltage VP into the low voltage VL, in the embodiment, the capacitor 120 of the NFC system 300 can have a higher voltage difference (e.g. 2.8V) than that of the NFC system 100 as shown in FIG. 1. Therefore, the capacitor 120 of the NFC system 300 can store more energy. Similarly, the memory device 150 is disposed in the independent power domain 140, and is further electrically coupled to the low voltage VL of the LDO 160. When the power source 110 is removed therefrom or turned off, the independent power domain 140 is supplied by only the capacitor 120 so that the memory device 150 can be used as an NVM. It is noted that the power source 110 of the NFC system 300 may be also supplied by a power system of an AP host chip, or even replaced with it, wherein the AP host chip may be another chip which is independent of the NFC system 300. In another embodiment, the power source 110 may be just a system battery of the NFC system 300.

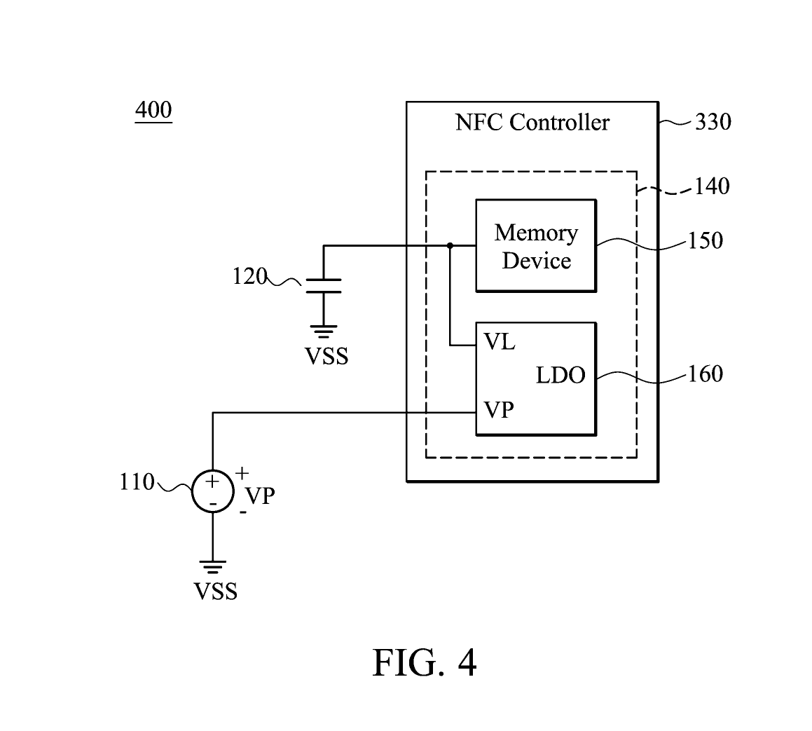

FIG. 4 is a diagram for illustrating an NFC system 400 according to another embodiment of the invention. The NFC system 400 is similar to the NFC system 300 as shown in FIG. 3. The only difference is that the capacitor 120 is moved to be electrically coupled to the low voltage VL of the LDO 160, not the power voltage VP.

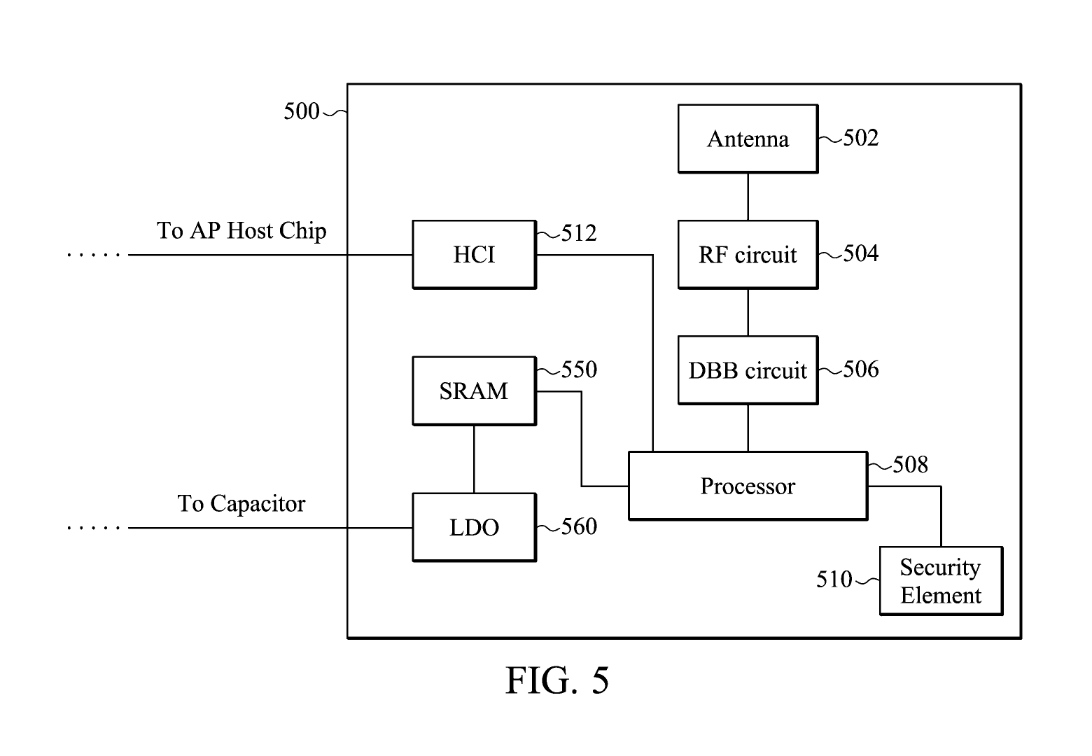

FIG. 5 is a diagram for illustrating an NFC controller 500 according to an embodiment of the invention. Besides the SRAM 550 and LDO 560, the NFC controller 500 may further comprise an antenna 502, an RF (Radio Frequency) circuit 504, a DBB (Digital Baseband) circuit 506, a processor 508, a security element 510, and an HCl (Host Control Interface) 512. The HCl 512 is electrically coupled to an AP host chip so as to obtain an input signal to be written into the SRAM 550. . The RF signal from RF circuit 504 is processed by DBB circuit 506 and then the DBB output data is fed into processor 508 for further manipulation. Security element 510 is optional and it stores the security data depending on application. Similarly, the LDO 560 is electrically coupled to a capacitor and to a power source. The NFC controller 500 can be applied in every embodiment of the invention.

The invention provides a novel NFC system with a capacitor which serves as a UBS (Uninterruptible Power Supply). Therefore, any kind of memory device of the NFC system can be used as an NVM. In a preferred embodiment, a volatile memory may be used in the NFC system, and it just requires a standard process. Neither special processes nor extra masks are required in the invention.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An NFC (Near Field Communication) system, comprising:
a power source;
a capacitor, charged by the power source;
an NFC controller, comprising an independent power domain which is supplied by the power source and/or the capacitor; and
a memory device, disposed in the independent power domain, and maintaining data,
wherein the independent power domain is supplied by the capacitor when the power source is removed therefrom or turned off

2. The NFC system as claimed in claim 1, wherein the power source is a system battery.

3. The NFC system as claimed in claim 1, wherein the power source is supplied by a power system of an AP (Application Processor) host chip which is independent of the NFC system.

4. The NFC system as claimed in claim 1, wherein the data comprises an application configuration data and/or a patch code.

5. The NFC system as claimed in claim 1, wherein the memory device is an SRAM (Static Random Access Memory).

6. An NFC (Near Field Communication) system, comprising:
a power source;
a capacitor, charged by the power source;
an NFC controller, comprising an independent power domain which is supplied by the power source and/or the capacitor;
an LDO (Low Dropout Regulator), disposed in the independent power domain, and converting a power voltage into a low voltage, wherein the power voltage is provided by the power source and/or the capacitor; and
a memory device, disposed in the independent power domain, coupled to the low voltage of the LDO, and maintaining data,
wherein the independent power domain is supplied by the capacitor when the power source is removed therefrom or turned off.

7. The NFC system as claimed in claim 6, wherein the power source is a system battery.

8. The NFC system as claimed in claim 6, wherein the power source is supplied by a power system of an AP (Application Processor) host chip which is independent of the NFC system.

9. The NFC system as claimed in claim 6, wherein the data comprises an application configuration data and/or a patch code.

10. The NFC system as claimed in claim 6, wherein the memory device is an SRAM (Static Random Access Memory).
